(19) United States
(12) Patent Application Publication
(10) Pub. No.: US 2017/0034999 A1
(43) Pub. Date: Feb. 9, 2017

(54) Landscape Edging Piece

(71) Applicant: Molded Products, Inc., Harlan, IA (US)

(72) Inventor: David E. Tyrrel, Harlan, IA (US)

(21) Appl. No.: 14/819,653

(22) Filed: Aug. 6, 2015

(51) Int. Cl. A01G 1/08

(52) U.S. Cl. CPC A01G 1/08

(57) ABSTRACT

A landscape edging piece which forms a boundary between a landscaped bed and a mowed lawn area. The edging piece has a top face that is inclined downwardly from the endwall that abuts the landscaped bed, so that the endwall that abuts the mowed area is at approximately lawn level. The edging piece is formed by molding and has integrally formed anchoring spikes that secure the piece in the desired location. The edging piece used in a landscaped area appears the same as a conventional paver, but is far less expensive to install since it does not require digging to place it in the proper position.

### BACKGROUND OF THE INVENTION

Field of the Invention

The present invention relates to the field of landscaping devices, and more particularly to a landscape edging piece that forms a boundary between a landscaped bed and a mowed lawn area.

Description of the Related Art

As can be seen by reference to the following U.S. Patent Publication Nos. 20013/0025194, 20050034362, 20090274513, and U.S. Pat. Nos. 6,460,298, 5,490,362 and 5,157,867 the prior art is replete with myriad and diverse landscape edging devices.

While all of the aforementioned prior art constructions are more than adequate for the basic purpose and function for which they have been specifically designed, they are uniformly deficient with respect to their failure to provide a simple, efficient, and practical landscape edging retaining wedge with integrally formed anchoring spikes.

As a consequence of the foregoing situation, there has existed a longstanding need for a new and improved landscape edging retainer piece and the provision of such a construction is a stated objective of the present invention.

### BRIEF SUMMARY OF THE INVENTION

Briefly stated, the present invention provides a landscape edging piece which forms a boundary between a landscaped bed and a mowed lawn area. The edging piece has a top face that is inclined downwardly from the endwall that abuts the landscaped bed, so that the endwall that abuts the mowed area is at approximately lawn level. The edging piece is formed by molding and has integrally formed anchoring spikes that secure the piece in the desired location. The edging piece used in a landscaped area appears the same as a conventional paver, but is far less expensive to install since it does not require digging to place it in the proper position.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view illustrating a landscaped area bordered by the landscape edging pieces of the present invention;

FIG. 2 is an enlarged sectional view taken along line 2-2 of FIG. 1, showing the edging piece secured by the integrally formed anchoring spikes in a location between the landscaped area and the mowed lawn area;

FIG. 3 is a perspective view of the edging piece;

FIG. 4 is a side elevational view thereof;

FIG. 5 is an end elevational view thereof;

FIG. 6 is a top plan view thereof; and

FIG. 7 is a bottom plan view thereof.

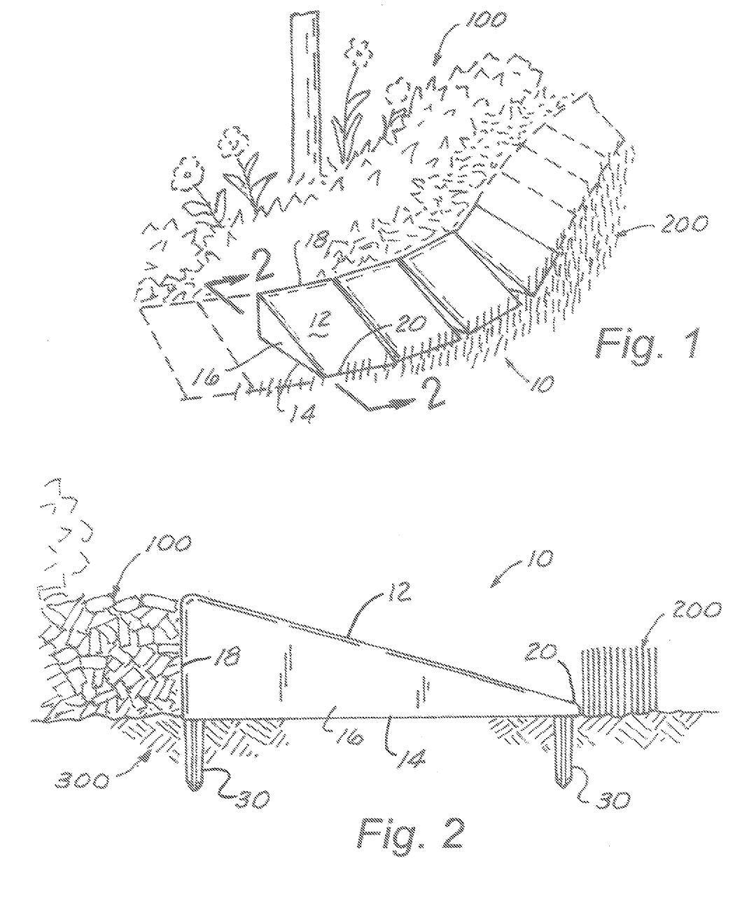

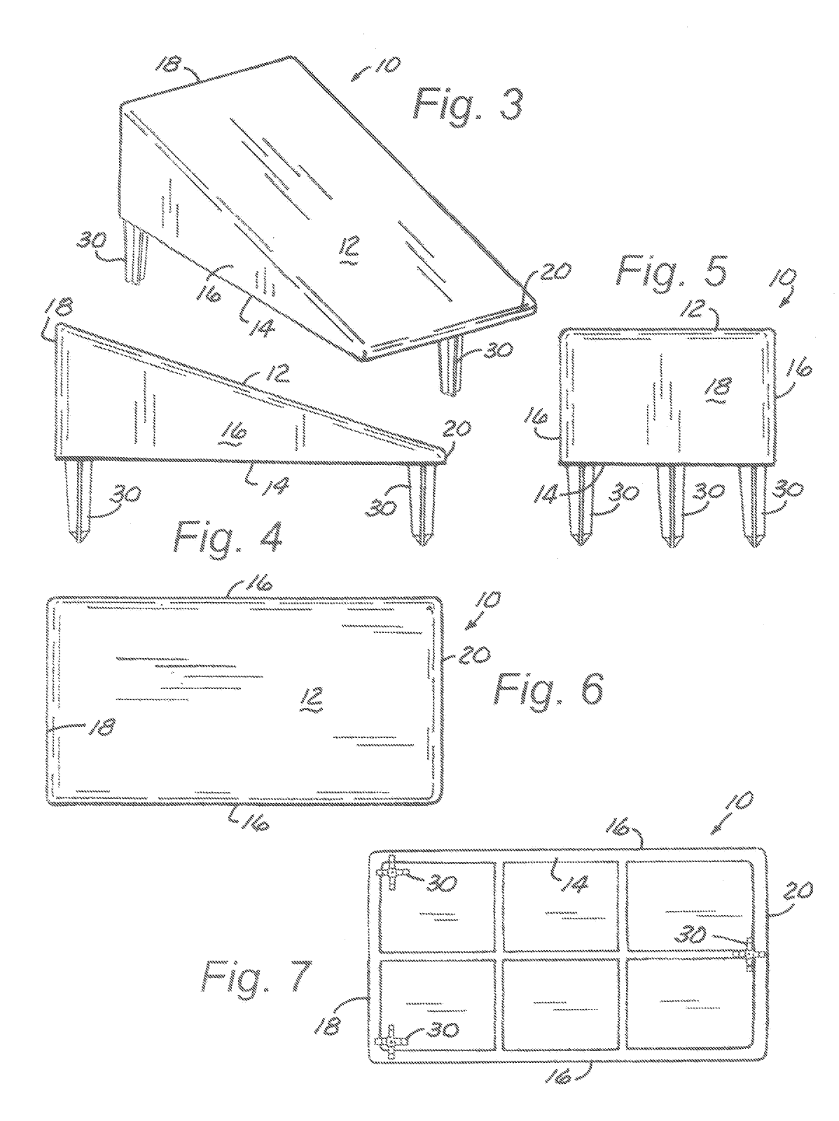

### DETAILED DESCRIPTION OF THE INVENTION

As can be seen by reference to the drawings, and in particular to FIG. 1, the landscape edging piece that forms the basis of the present invention is designated generally by the reference number (10). The edging piece (10) has a body member (12) that includes a rectangular base (14), sidewalls (16), a first endwall (18) extending up from the base (14), a second endwall (20), and a top face that extends downwardly from the first endwall (18) that abuts the landscaped area (100), to the second endwall (20) that abuts the mowed lawn area (200).

The edging piece (10) is formed by molding, and includes a plurality of integrally formed anchoring spikes (30) that extend downwardly from the base (14) to engage the soil (300) and secure the edging piece (10) in its desired position.

The edging piece (10) acts as a barrier between grass (200) and flower beds, gardens, rock, bark, or other bedding material (100). Each edging piece (10) is staked into the ground (300) which locates the piece (10), and resists movement. The piece (10) functions much like a common brick “paver.” The unique feature of the present invention is that the piece (10) is tapered to give the appearance of being partially dug in to the ground (300) without having to actually dig up the ground (300). The advantage of this is that a lawn mower can cut over the top of the piece (10), eliminating the need for additional trimming. The present invention provides a trim free solution, and an appearance that is common with traditional pavers, without being labor intensive.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

1. A landscape edging piece, comprising:
a body member, the body member including a base, a first endwall extending up from the base, a second endwall, a top face extending downwardly from the first endwall to the second endwall, and sidewalls extending between the base and the top face; and
a plurality of anchoring spikes integrally formed with the body member in an orientation extending down from the body member to penetrate a ground surface.

2-5. (canceled)

6. The landscape edging piece of claim 1, wherein the top surface is inclined at an angle of about 25° with respect to the base.

7. The landscape edging piece of claim 1, wherein the second endwall is coincident with a side of the base.

8. The landscape edging piece of claim 1, wherein the base is rectangular.

9. The landscape edging piece of claim 1, wherein the body member is hollow.

10. The landscape edging piece of claim 1, wherein the edging piece is formed by molding.

11. A method of finishing a landscaped area including a boundary between a landscaped bed and a mowed lawn area, the method comprising the steps of:
placing a plurality of landscaped edging pieces, according to claim 1, in a side-by-side relationship along the boundary between the landscaped bed and the mowed lawn area;
wherein the first end wall of each edging piece is positioned adjacent the landscaped bed, and the second end wall is positioned adjacent the mowed lawn area; and
wherein the anchoring spike is positioned to extend downwardly into a soil base.
